(19) United States
(12) Patent Application Publication
(10) Pub. No.: US 2013/0099508 A1
(43) Pub. Date: Apr. 25, 2013

(54) METHODS FOR USING A CARBON DIOXIDE CAPTURE SYSTEM AS AN OPERATING RESERVE

(71) Applicants: Nareshkumar B. Handagama, Knoxville, TN (US); Rasesh R. Kotdawala, Knoxville, TN (US); Vikram S. Shabde, Pearland, TX (US)

(72) Inventors: Nareshkumar B. Handagama, Knoxville, TN (US); Rasesh R. Kotdawala, Knoxville, TN (US); Vikram S. Shabde, Pearland, TX (US)

(73) Assignee: ALSTOM TECHNOLOGY LTD., Baden (CH)

(21) Appl. No.: 13/276,466

(22) Filed: Oct. 19, 2011

(51) Int. Cl. H02P 9/04; F22B 3/00; F01K 13/00

(52) U.S. Cl. 290/40 B; 60/645; 122/6 R

(57) ABSTRACT

A method of controlling a power system includes monitoring a load on an electrical grid, monitoring a power generation from one or more power producers connected to the electrical grid, wherein at least one of the one or more power producers is a power plant including a carbon dioxide capture system, and utilizing the carbon dioxide capture system of the one or more power producers as a operating reserve in response to an increase in the load on the electrical grid or a reduction in the power generation from one or more power producers connected to the electrical grid.

### BACKGROUND

The present disclosure relates generally to systems and processes for controlling a electric power system. More specifically, the present disclosure relates to systems and processes configured to control a power system including one or more power plants integrated with a carbon dioxide capture system.

Most of the energy used in the world today is derived from the combustion of carbon and hydrogen containing fuels such as coal, oil and natural gas, as well as other organic fuels. Such combustion generates flue gases containing high levels of carbon dioxide, a green house gas (GHG). Due to concerns about global warming, power plants that include carbon dioxide capture systems have been developed. These carbon dioxide capture systems require a substantial amount of energy to operate and therefore reduce the efficiency of the power plants.

Electrical power consumption varies by the minute, hour and day. Changes in both load and generation can result in a power imbalance in the grid. These changes are not predictable or scheduled in advance. Since the power balance must be continuously maintained, a system operator typically is responsible for balancing power generation from one or more power producers to match the load.

During operational hours, system operators monitor the power system operation and communicate with producers that have generators or loads as available reserves, which can be activated depending on the need to balance power system imbalances. Different types of reserves are available to system operators and each type of reserve has unique operating characteristics. Various system and method for providing and managing reserves to balance power system imbalances have been proposed.

### BRIEF SUMMARY

Exemplary embodiments of the present disclosure include a method of controlling a power system includes monitoring a load on an electrical grid, monitoring a power generation from one or more power producers connected to the electrical grid, wherein at least one of the one or more power producers is a power plant including a carbon dioxide capture system, and utilizing the carbon dioxide capture system of the one or more power producers as a operating reserve in response to an increase in the load on the electrical grid or a reduction in the power generation from one or more power producers connected to the electrical grid.

Exemplary embodiments of the present disclosure also include a method of controlling a power system including one or more power plants, which power plant include: a power plant boiler being adapted for combusting an organic fuel and for generating steam and a process gas including carbon dioxide; a steam system being adapted for utilizing at least a portion of the energy content of at least a first portion of the steam generated by the power plant boiler; and a carbon dioxide capture system being adapted to remove at least a portion of the carbon dioxide from at least a portion of the process gas by contacting a carbon dioxide absorbent solution with the process gas such that carbon dioxide from the process gas generated in the power plant boiler is captured by the carbon dioxide absorbent making the carbon dioxide absorbent rich in carbon dioxide, the method including: forwarding a second portion of the steam produced by the power plant boiler to a regenerator of the carbon dioxide capture system; forwarding the first portion of the steam produced by the power plant boiler to the steam system; and controlling a magnitude of the first and second portion of the steam produced by the power plant boiler by means of at least one automatic controller; wherein the automatic controller reduces the magnitude of the second portion of the steam produced by the power plant boiler in response to an increased demand in power output of the power plant.

Exemplary embodiments of the present disclosure also include a method for providing an operating reserve to a power plant including: detecting a load imbalance; reducing a first percentage of steam from a boiler forwarded to a carbon dioxide capture system; increasing a second percentage of steam from the boiler forwarded to a steam cycle for electric generation; and maintaining a CO₂ capture setpoint of the carbon dioxide capture system.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 is a graph illustrating the time periods over which the various kinds of reserve power are available to a system operator in response to a disruption in power supply or a spike in demand.

FIG. 2 is a flow chart illustrating the operation of a power plant according to an embodiment of the present disclosure.

FIG. 3 is a schematic view of a power plant with a carbon capture system according to an embodiment of the present disclosure.

FIG. 4 is a graph illustrating the performance of an absorber in response to a reduction in the amount of steam forwarded to the reboiler by 10%.

FIG. 5 is a graph illustrating the performance of an absorber in response to a reduction in the amount of steam forwarded to the reboiler by 20%.

FIG. 6 is a graph illustrating the performance of an absorber in response to a reduction in the amount of steam forwarded to the reboiler by 50%.

### DETAILED DESCRIPTION

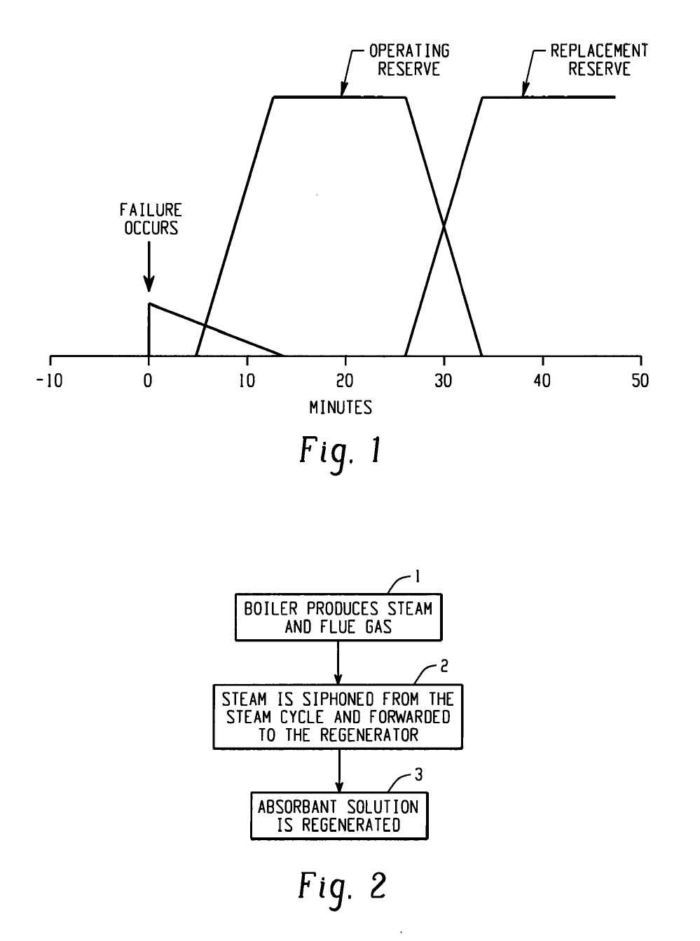

FIG. 1 is a graph illustrating the time periods over which the various types of reserve power are available to a system operator in response to a disruption in power supply or a spike in demand. In electricity network grids, the operating reserve is the generating capacity available to the system operator within a short interval of time to meet increases in demand that are caused by a generator going down or another disruption of power supply. Most power systems are designed so that, under normal conditions, the operating reserve is at least the capacity of the largest generator plus a fraction of the anticipated peak load.

The operating reserve is made up of a spinning reserve as well as a non-spinning or supplemental reserve. The spinning reserve is the extra generating capacity that is available by increasing the power output of generators that are already connected to the power system. For most generators, this increase in power output is achieved by increasing the torque applied to the turbine's rotor. The non-spinning or supplemental reserve is the extra generating capacity that is not currently connected to the system but can be brought online after a short delay. In isolated power systems, the non-spinning reserve typically equates to the power available from fast-start generators. However in interconnected power systems, the non-spinning reserve may include the power available on short notice by importing power from other systems or retracting power that is currently being exported to other systems. Generators that are designated to provide either spinning or non-spinning reserve should be able to reach their promised capacity within approximately ten minutes. Most power system guidelines require a significant fraction of their operating reserve to come from spinning reserve because the spinning reserve is more reliable and can respond immediately whereas with non-spinning reserve generators there is a delay as the generator starts-up off-line.

The frequency-response reserve, or regulating reserve, is provided as an automatic reaction to a loss in supply immediately following a loss of supply when the generators slow down due to the increased load. To combat this slowing, many generators have a governor, a device to maintain the speed. By helping the generators to speed up, these governors provide a small boost to both the output frequency and the power of each generator. Because the frequency-response reserve is small and not controlled by the system operator, it is not considered as a part of the operating reserve.

The replacement reserve, or contingency reserve, is reserve power provided by generators that require a longer start-up time, such as thirty to sixty minutes. The replacement reserve is used to relieve the generators providing the spinning or non-spinning reserve and thus restore the operating.

Referring now to FIG. 2, a flow chart illustrating the operation of a power plant illustrated. As illustrated at block 1, a power plant boiler combusts organic fuel to boil water and produce steam. The steam is forwarded through piping to a steam cycle comprising steam turbines for power production, generation of electricity, and the flue gas from the combustion of the organic fuel is forwarded through ducting to a gas cleaning system, in which gas cleaning system particles, sulphur and nitrogen containing pollutants etc. are removed from the flue gas. Next, the cleaned flue gas is forwarded to the carbon dioxide capture system where carbon dioxide is captured from the flue gas by an absorbent solution.

At block 2, a mixture of intermediate pressure (IP) steam and low pressure (LP) steam is siphoned off from the steam cycle and forwarded to the regenerator of the carbon dioxide capture system. The amount of steam siphoned off may be controlled by at least one automatic controller. Next, as illustrated at block 3, the hot steam forwarded from the steam cycle exchanges heat with carbon dioxide rich absorbent solution in a reboiler included in the regenerator. In the regenerator, the carbon dioxide rich absorbent solution is boiled, producing a relatively pure carbon dioxide gas stream which is forwarded to a compressor for compression and subsequent storage. At least a substantial part of the carbon dioxide captured by the absorbent solution is thus removed from the absorbent solution, resulting in a lower concentrated or lean absorbent solution which is returned to the carbon dioxide removing absorber system for capturing more carbon dioxide from flue gas passing through.

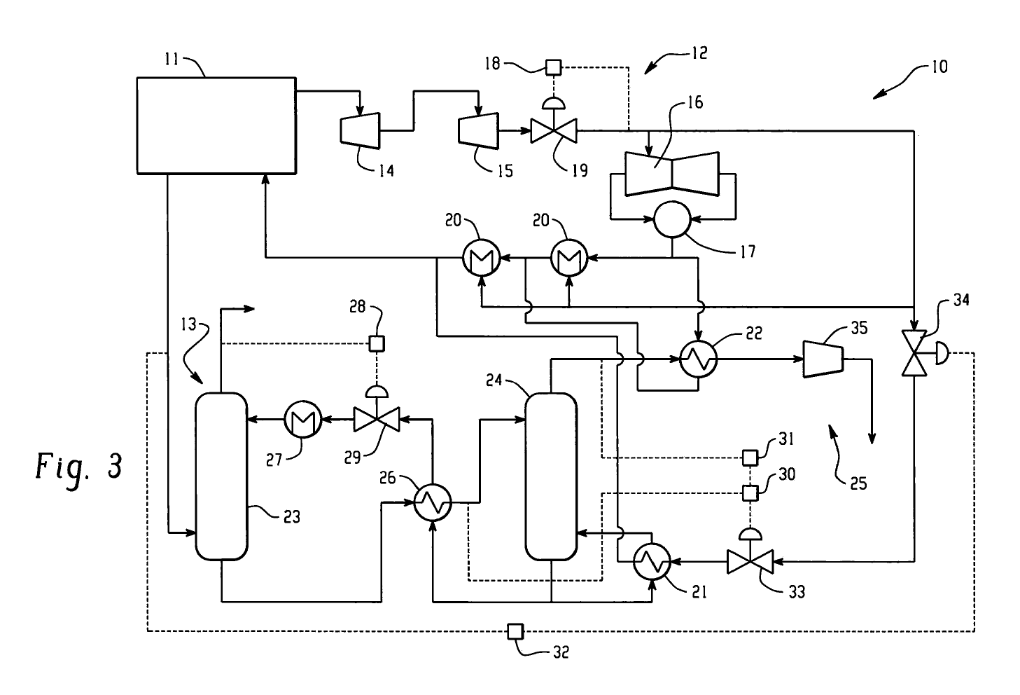

Referring now to FIG. 3, a power plant 10 in accordance with the present disclosure is shown. The power plant 10 includes a boiler 11, a steam cycle 12 and a carbon dioxide capture system 13. The steam cycle 12 includes a high pressure turbine 14, an intermediate pressure turbine 15 and a low pressure turbine 16, as well as a condenser 17. Steam from the boiler 11 will pass through the turbines 14, 15 and 16 in sequence during expansion and cooling, after which steam having passed the low pressure turbine 16 will be condensed in the condenser 17 at lower temperature and pressure. The cold condensate from the condenser 17 may then be forwarded as boiler feedwater towards the boiler 11 to be recycled for continuous steam production. Before reaching the boiler the boiler feedwater will be heated by the two boiler feedwater heaters 20 to reduce the heating load of the boiler 11, after which the feedwater re-enters the boiler 11 to complete the steam cycle 12. Some of the condensate from the condenser 17 is used as cooling medium in the CO₂ compression heat exchanger 22 and is heated before being returned to the steam cycle as boiler feedwater, reducing the heating load of the boiler feedwater heaters 20.

In exemplary embodiments, some of the steam is siphoned away from the steam cycle after it has passed the intermediate pressure turbine 15 but before it has entered the low pressure turbine 16. This steam is used as heating medium in the regenerator reboiler 21, and then forwarded and used as heating medium in the boiler feedwater heaters 20. Since the backpressure at the IP-LP crossover ensures supply of steam to both the LP turbine 16 and to the reboiler 21, this pressure is maintained in the face of changing steam flow to the LP feedwater heaters 20. This is achieved through a pressure controller 18 acting on valve 19.

In exemplary embodiments, the carbon dioxide capture system includes an absorber 23 in which flue gas from the boiler 11 may contact absorbent solution, whereby carbon dioxide is captured from the flue gas by the absorbent solution. The carbon dioxide capture system also includes a regenerator 24 in which carbon dioxide rich absorbent solution from the absorber 23 may be regenerated through heating by means of the reboiler 21 to produce a carbon dioxide lean absorbent solution that may be returned to the absorber 23 as well as a carbon dioxide rich gas stream that may leave the regenerator 24. In addition, the carbon dioxide capture system includes and a carbon dioxide compression arrangement 25. In one embodiment, the carbon dioxide capture system 13 may include using an amine in carbon dioxide separation, such as monethanolamine (MEA), methyldiethanolamine (MDEA), or another suitable amine. In another embodiment, the carbon dioxide capture system 13 may include using chilled ammonia for carbon dioxide separation.

In one embodiment, the absorber 23 admits flue gas from the boiler 11 and carbon dioxide unsaturated or lean absorbent solution from the regenerator 24 and, optionally, from another lean absorbent solution source of fresh lean absorbent solution (not shown). The absorbent solution may be re-circulated in the absorber 23. The lean solution from the regenerator 24 may be cooled by heat exchangers 26 and/or 27 before entering the absorber 23. In heat exchanger 26, the lean solution may be cooled by the rich solution leaving the absorber 23 and heading to the regenerator 24. In heat exchanger 27, the lean solution may be additionally cooled by a regular cooling medium such as cold water. Apart from emitting rich absorbent solution, the absorber 23 is also arranged to emit carbon dioxide lean flue gas, i.e., the flue gas after being contacted with the absorbent solution. This lean flue gas exits the power plant 10 and may be emitted to the atmosphere.

The feedback controller 28 is used to control the amount of CO₂ capture in the absorber 23 even if the amount of flue gas entering the absorber 23 changes. This controller 28 maintains the ratio of lean absorbent solution and flue gas entering the absorber 23 to a set value, typically the design value, by acting on a valve of the lean solution stream, e.g. between the heat exchangers 26 and 27, based on the carbon dioxide content of the flue gas leaving the absorber 23.

The regenerator 24 admits carbon dioxide rich absorbent solution from the absorber 23 after having passed through the heat exchanger 26, and emits carbon dioxide lean absorbent solution to the absorber 23 via the heat exchangers 26 and 27 as well as a carbon dioxide rich gas stream leaving the regenerator 24 and entering the carbon dioxide compression arrangement 25. The regenerator 24 includes the reboiler 21 which is a heat exchanger in which steam from the steam cycle is used to heat the carbon dioxide rich absorbent solution admitted into the regenerator 24 from the absorber 23. During this heating, carbon dioxide captured by the absorbent solution leaves the solution as a carbon dioxide rich gas, or essentially pure carbon dioxide, whereby the absorbent solution is regenerated and may be returned to the absorber 23.

One or more controllers 30, 31 and 32 shown in FIG. 3 may be used to control the amount of steam input to the reboiler 21 in view of the overall operation of the power plant 10. The rich absorbent solution stream entering the regenerator 24 may also have different flow and/or different CO₂ composition if the flue gas load of the carbon dioxide capture system changes. To minimize the energy consumed by the reboiler 21, the steam flow rate may be controlled by a controller 30 based on the rich absorbent solution stream entering the regenerator. This will be a feedforward controller 30. Alternatively, or additionally, a controller 32 could be used, which uses a measurement of the flue gas stream to the absorber 23 for feedforward control of the steam flow to the reboiler 21. To provide finely tuned control for the regeneration of solution in the regenerator a feedback controller 31 may further regulate the steam flow to the reboiler 21 based on a temperature in the regenerator, such as the temperature of the CO₂ rich gas stream leaving the regenerator or at any intermediate stage in the regenerator. The controllers 30, 31 and 32 may control the operation of a valve 33 of the steam stream just before it enters reboiler 21 and/or on a throttling valve 34 after the IP-LP crossover. In one embodiment, controllers 30 and 31 controls valve 33, and controller 32 controls valve 34.

The power plant 10 includes piping that connects the different parts of the system and is arranged to allow steam, absorbent solution, process gas etc., respectively, to flow within the power plant as needed. The piping may also include valves, pumps, nozzles, heat exchangers etc. as appropriate to control the flows.

In exemplary embodiments, the carbon dioxide compression system 25 includes the heat exchanger 22 and the compressor 35. The compressor 35 may compress the carbon dioxide rich gas stream from the regenerator to facilitate storage of the carbon dioxide, which may be essentially pure. The carbon dioxide may be compressed to liquid form. The compressed carbon dioxide leaves the power plant 10 and may be sold or more permanently stored to avoid emission to the atmosphere.

In accordance exemplary embodiments, the carbon dioxide capture system 13 of the power plant 10 may be leveraged to provide an additional operating reserve to both the power plant 10 and to the power system that the power plant 10 is apart of. Carbon dioxide capture systems require a substantial load for operation and are extremely slow to respond to load changes compared to the response time of the electrical grid. Accordingly, the carbon dioxide capture system 13 can be utilized as an available load or operating reserve. In one embodiment, a thermo-chemical spinning reserve, the extra generating capacity that is available in the power plant 10, can be accessed by shutting down the reboiler 21, which may be consuming as much as approximately 20% of the steam output of the boiler 11. By shutting down the reboiler 21, the available power output of the power plant 10 is immediately increased and available for use by the power system. In exemplary embodiments, the reboiler 21 can be completely shut down or partially shut down by reducing the amount of steam forwarded to the reboiler 21. While the steam that was previously used by the reboiler 21 is being used to generate electricity, the thermo-chemical energy in the solvent will be used to continue operating the carbon dioxide capture system 13 for a limited time, e.g., 0 to 15 minutes. During this time period, the required CO₂ capture (e.g., 90%) will be maintained.

In another exemplary embodiment, a non-spinning or supplemental thermo-chemical reserve can also be accessed by leveraging the carbon dioxide capture system 13 of the power plant 10. The steam that was previously used by the reboiler 21 can continued to be used to produce electricity after the limited period of time in which the thermo-chemical energy in the solvent was used to operate the carbon dioxide capture system 13. At this point, regeneration of the solvent will be stopped or de-rated, consequently the CO₂ loading in the solvent will rise, reducing the CO₂ absorbing capacity of the solvent. When the CO₂ capture rate goes down, e.g., set point 89%, then a portion of the rich solvent will be stored and an equal portion of fresh solvent will be charged in to the solvent loop, so as to maintain the set point without any interruption to CO₂ capture.

Most power system guidelines require a significant fraction of the operating reserve to come from a spinning reserve because the spinning reserves are more reliable and can respond immediately, e.g., they do not have start-up delays. In exemplary embodiments, the non-spinning thermo-chemical reserve may be treated as a spinning reserve because it will not have any delays typically associated with non-spinning reserves. By controlling the steam flow to the reboiler 21, therefore controlling the CO₂ rich loading in the solvent, steam will be diverted from the carbon dioxide capture system for electricity production. The resulting thermo-chemical reserve can be utilized as a part of the operating reserve. In exemplary embodiments, the thermo-chemical reserve could act as a frequency response reserve, e.g., for 0 to 30 seconds up to 60 seconds after a disruption in service, or as a operating reserve, e.g., for 15 to 30 minutes after a disruption in service.

When the absorbent solution is referred to as “lean” (e.g., when contacting the process gas in the carbon dioxide capture system, or after regeneration) the absorbent solution is unsaturated with regard to carbon dioxide and may thus capture more carbon dioxide from the process gas. When the absorbent solution is referred to as “rich” (e.g., after contacting the process gas in the carbon dioxide capture system, or prior to regeneration) the absorbent solution is saturated, or at least almost saturated, or oversaturated with regard to carbon dioxide and may thus need to be regenerated before being able to capture any more carbon dioxide from the process gas or the carbon dioxide may be precipitated as a solid salt.

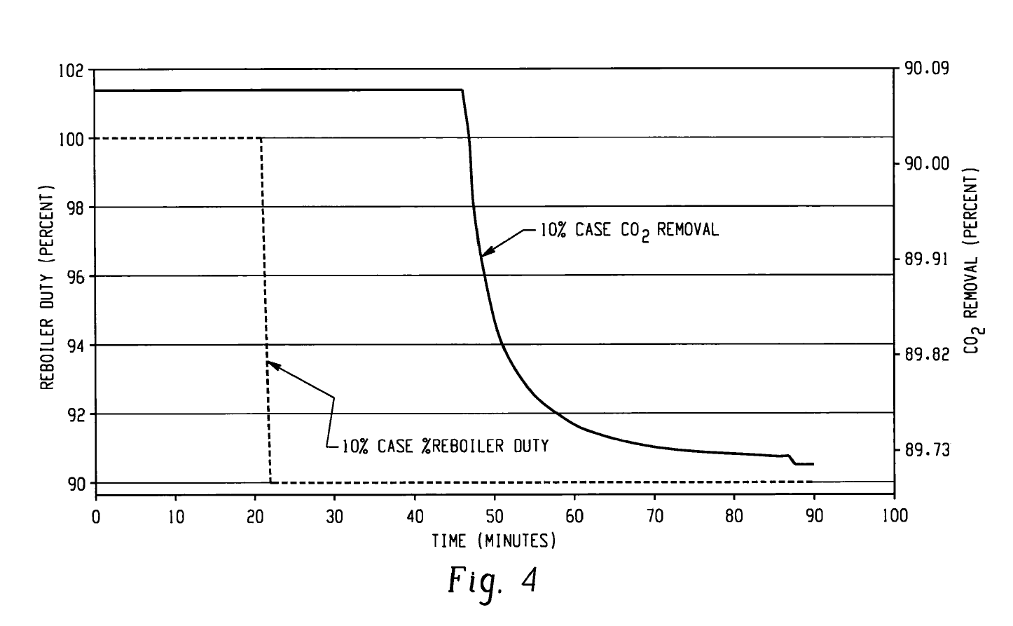

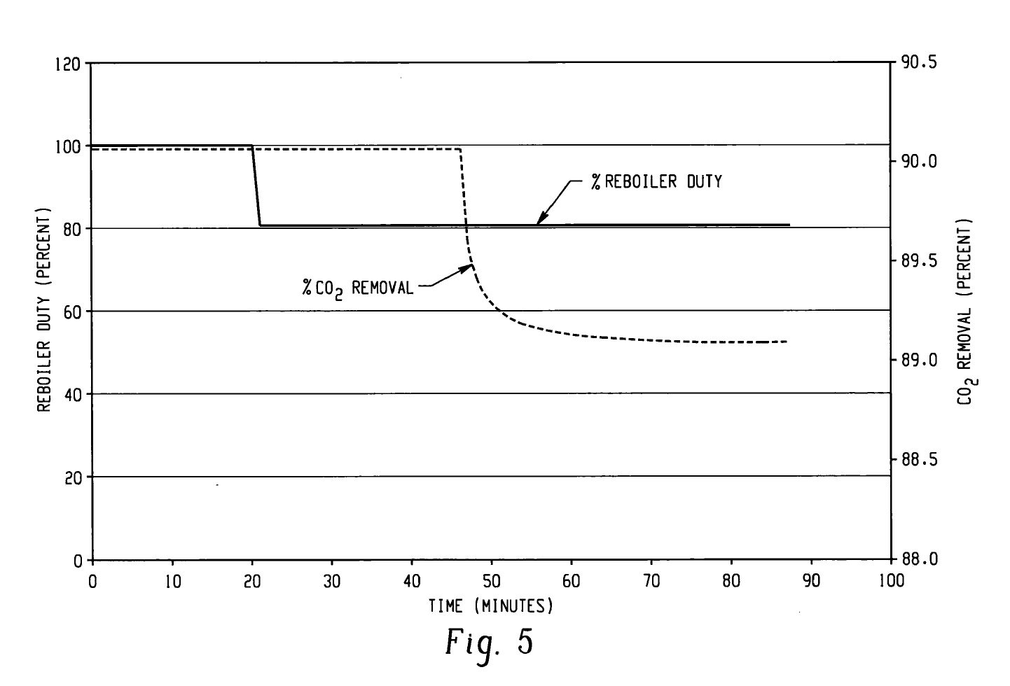

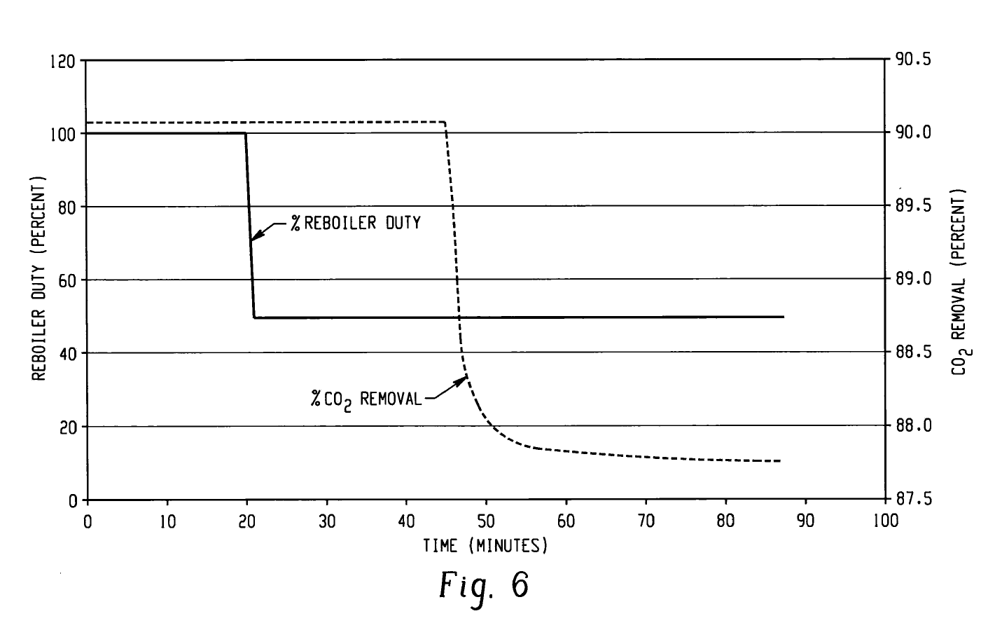

FIGS. 4, 5 and 6 illustrate the performance of the absorber 23 in response to reductions in the amount of steam forwarded to the reboiler 21 by 10%, 20% and 50%, respectively. As shown in FIG. 4, for a reduction of steam forwarded to the reboiler 21 by 10% the CO₂% removal is maintained more than 90% for more than 25 minutes. As shown in FIG. 5, for a reduction of steam forwarded to the reboiler 21 by 20% the CO₂% removal is maintained more than 89% for more than 20 minutes. Accordingly, the carbon dioxide capture system 13 can be utilized as an available load, or operating reserve, to provide a thermo-chemical spinning reserve while still maintaining the required CO₂ capture rate.

In an exemplary embodiment, a power system includes one or more power plants, which each include a power plant boiler that combusts an organic fuel and generates steam and a process gas, including carbon dioxide. The power plant also includes a steam system that utilizes at least a portion of the energy content of at least a portion of the steam generated by the power plant boiler. Finally, the power plant includes a carbon dioxide capture system that removes at least a portion of the carbon dioxide from at least a portion of the process gas by contacting a carbon dioxide absorbent solution with the process gas such that carbon dioxide from the process gas generated in the power plant boiler is captured by the carbon dioxide absorbent making the carbon dioxide absorbent rich in carbon dioxide.

In exemplary embodiments, the power plant the carbon dioxide capture system is operated by an automatic controller that forwards a regenerator portion of the steam produced by the power plant boiler to a regenerator of the carbon dioxide capture system. The carbon dioxide capture system at least partly regenerates the absorbent solution in the regenerator through heating of the carbon dioxide absorbent solution when it is rich in carbon dioxide, by means of the forwarded steam to make the absorbent solution carbon dioxide lean. By regenerating the absorbent solution, the absorbent solution may be reused in the carbon dioxide capture system for removing carbon dioxide from the process gas. Utilizing steam from the power plant boiler for regeneration of the absorbent solution eliminates the need for a separate heat source for heating the absorbent solution and simplifies the power plant design. In some cases, the power needed to regenerate the absorbent solution with an electrical heater may be more than the loss in power production from forwarding a portion of the boiler produced steam to the regenerator.

In exemplary embodiments, the carbon dioxide capture system is integrated into the power plant, both by the carbon dioxide capture system removing carbon dioxide from the process gas from the boiler and by steam from the boiler being forwarded to the regenerator of the carbon dioxide capture system. By integrating the carbon dioxide capture system in the power plant, the operation of the carbon dioxide capture system may be better and more easily adapted to the operation and requirements of the rest of the power plant. Also, the power output of the whole power plant, including the carbon dioxide capture system, may be more easily observed and controlled. Accordingly, the power plant control system can control the operation the carbon dioxide capture system and utilize it as an operating reserve to the power plant.

In exemplary embodiments, the operation of the carbon dioxide capture system may be controlled automatically by a plurality of automatic controllers. This may facilitate increased automatic control of the carbon dioxide capture system, and may also increase the system's adaptability to act as an operating reserve for the power plant. The control may be more precise and finely tuned with a plurality of automated controllers. For example, the plurality of controllers may be used to precisely control the percentage of steam from the boiler that is used by the carbon dioxide capture system and the steam system. The plurality of controllers may also be controlled by an automatic master controller. In exemplary embodiments, the operating reserve can be used for a variety of purposes including, but not limited to, generating power to meet peak demand of the power system, generating power for starting the power plant, peaking another power plant, or to provide power to auxiliary equipment.

The automatic master controller may be part of an optimization system arranged to optimize the overall operation of the power system. The carbon dioxide capture system may be operated in relation to the rest of the power system in order to enhance the operation of the power system as a whole. The optimization may be performed by continuously calculating and assigning setpoints to the at least one controller. By recalculating and reassigning setpoints to the controller, the operation of the carbon dioxide capture system may be automatically controlled and adapted to the operation of the whole power system to provide an operating reserve to the power system as operational parameters or other conditions relevant to the operation of the power system change over time.

The operation of the power plant including the carbon dioxide capture system may be optimized with regard to power output of the power plant, while maintaining carbon dioxide capture at a prescribed level. The level might be a prescribed total amount of captured carbon dioxide per time unit or per process gas volume unit, or a captured percentage of the carbon dioxide of the process gas entering the carbon dioxide capture system, or a carbon dioxide concentration of the process gas leaving the carbon dioxide capture system. The power output may thus be maximized while still making sure that government prescribed maximum carbon dioxide emissions are not exceeded. The operation of the power plant including the carbon dioxide capture system may be optimized such that the optimization includes a tradeoff between the power output of the power plant and the carbon dioxide capture level. The power plant may further optimize the usage of the carbon dioxide capture system by utilizing the power generation capacity carbon dioxide capture system as part of its operating reserve.

In an exemplary embodiment, the carbon dioxide capture system may include an absorber arrangement in which the process gas is contacted with an absorbent solution amount provided to the absorber arrangement, whereby carbon dioxide is captured from the process gas by the absorbent solution in the absorber arrangement. The absorber arrangement may be arranged to facilitate the contact between the process gas and the absorbent solution. The absorbent arrangement may include one or a plurality of absorbers. A controller maybe used to control the amount of absorbent solution provided to the absorber arrangement at least partially based on a measured value of at least one variable related to properties of a stream of the process gas. The stream of process gas leaving the absorber arrangement may have a lower carbon dioxide content than the process gas entering the absorber arrangement since carbon dioxide may have been captured from the process gas by the absorbent solution. The absorbent solution may be any solution able to capture carbon dioxide from a process gas, such as an ammoniated solution or an aminated solution. The capturing of CO₂ from the process gas by the absorbent solution may be achieved by the absorbent solution absorbing or dissolving the CO₂ in any form, such as in the form of dissolved molecular CO₂ or a dissolved salt.

The steam system may include one or a plurality of steam turbines, linked to one or a plurality of generators for power production. In one embodiment, at least three serially linked turbines designed to operate at different steam pressures are used in the steam system. These turbines may be called high pressure turbine, intermediate pressure turbine and low pressure turbine, respectively. After passing through the low pressure turbine, the steam may be condensed in the condenser of the power plant. Steam from the boiler, prior to passing through the high pressure turbine may typically have a pressure of 150-350 bar. Steam between the high pressure turbine and the intermediate pressure turbine is called high pressure steam and may typically have a pressure of 62-250 bar. Steam between the intermediate pressure turbine and the low pressure turbine is called intermediate pressure steam and may typically have a pressure of 5-62 bar, such as 5-10 bar, and a temperature of between 154° C. and 277° C. (310° F. and 530° F.). Steam after passing the low pressure turbine is called low pressure steam and may typically have a pressure of 0.01-5 bar, such as 3-4 bar, and a temperature of between 135° C. and 143° C. (275° F. and 290° F.).

In exemplary embodiments, all or at least a portion of the steam sent to the regenerator may be siphoned off from a steam stream after the steam stream has passed through at least one steam turbine of the steam system. The steam generated by the boiler may be used to produce power by means of one or a plurality of turbines in the power plant steam system, before it is siphoned off to the regenerator. The regenerator portion of steam forwarded to the regenerator may be any steam, of any pressure and temperature, directly or indirectly from the boiler. The steam forwarded to the regenerator may be intermediate pressure steam or low pressure steam, or a mixture of intermediate and low pressure steam.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of controlling a power system comprising:
monitoring a load on an electrical grid;
monitoring electrical power generation from one or more power producers connected to the electrical grid, wherein at least one of the one or more power producers is a power plant comprising a carbon dioxide capture system; and
utilizing the carbon dioxide capture system of the one or more power producers as a operating reserve in response to an increase in the load on the electrical grid or a reduction in the electrical power generation from one or more power producers connected to the electrical grid.

2. The method of claim 1, wherein utilizing the carbon dioxide capture system of the one or more power producers as the operating reserve comprises reducing a portion of steam produced by a power plant boiler forwarded to a regenerator of the carbon dioxide capture system and increasing a portion of steam produced by the power plant boiler forwarded to a steam system of the power plant.

3. The method of claim 1, wherein the carbon dioxide capture system is controlled by a closed loop control system, which is integrated with a plant control system of the power plant.

4. The method of claim 1, further comprising maintaining a CO2 capture setpoint of the carbon dioxide capture system.

5. The method of claim 1, wherein utilizing the carbon dioxide capture system of the one or more power producers as the operating reserve comprises changing a solvent regeneration rate of the carbon dioxide capture system to control steam consumption of the carbon dioxide capture system.

6. The method of claim 2 wherein utilizing the carbon dioxide capture system of the one or more power producers as the operating reserve comprises exploiting a difference in response times of the steam system of the power plant and the carbon dioxide capture system of the power plant to provide a thermo-chemical spinning reserve.

7. A method of controlling a power system comprising one or more power plants, which power plant comprises:
a power plant boiler being adapted for combusting an organic fuel and for generating steam and a flue gas comprising carbon dioxide;
a steam system being adapted for utilizing at least a portion of the energy content of at least a first portion of the steam generated by said power plant boiler; and
a carbon dioxide capture system being adapted to remove at least a portion of the carbon dioxide from at least a portion of said flue gas by contacting a carbon dioxide absorbent solution with the flue gas such that carbon dioxide from said flue gas generated in the power plant boiler is captured by the carbon dioxide absorbent making the carbon dioxide absorbent rich in carbon dioxide, the method comprising:
forwarding a second portion of the steam produced by the power plant boiler to a regenerator of the carbon dioxide capture system;
forwarding the first portion of the steam produced by the power plant boiler to the steam system; and
controlling a magnitude of the first and second portion of the steam produced by the power plant boiler by means of at least one automatic controller;
wherein the automatic controller reduces the magnitude of the second portion of the steam produced by the power plant boiler and tapped from a IP-LP crossover in response to an increased demand in power output of the power plant demanded by the power system.

8. The method of claim 7, wherein the carbon dioxide capture system of the one or more power plants is utilized as an spinning reserve for the power system.

9. The method of claim 7, wherein the carbon dioxide capture system is controlled by a closed loop control system, which is integrated with a plant wide control system of the power plant.

10. The method of claim 7, further comprising maintaining a CO2 capture setpoint of the carbon dioxide capture system.

11. The method of claim 7, further comprising changing a solvent regeneration rate of the carbon dioxide capture system to control power consumption of the carbon dioxide capture system.

12. The method of claim 8, wherein utilizing the carbon dioxide capture system of the one or more power plants as the spinning reserve comprises exploiting a difference in response times of the steam system of the power plant and the carbon dioxide capture system of the power plant to provide a thermo-chemical spinning reserve.

13. A method for providing an operating reserve to a power plant comprising:
detecting a load imbalance;
reducing a first percentage of steam from a boiler forwarded to a carbon dioxide capture system;
increasing a second percentage of steam from the boiler forwarded to a steam cycle; and
maintaining a CO₂ capture setpoint of the carbon dioxide capture system.

14. The method of claim 13, wherein a controller detects the load imbalance and automatically reduces the first percentage of steam and increases the second percentage of steam by an amount sufficient to offset the load imbalance.

15. The method of claim 13, further comprising changing a solvent regeneration rate of the carbon dioxide capture system to control power consumption of the carbon dioxide capture system.

16. The method of claim 13, wherein the carbon dioxide capture system is controlled by a closed loop control system, which is integrated with a plant control system of the power plant.
